(19) United States
(12) Patent Application Publication
(10) Pub. No.: US 2007/0113174 A1
(43) Pub. Date: May 17, 2007

(54) METHOD OF PERFORMING LAYOUT OF CONTENTS AND APPARATUS FOR THE SAME

(76) Inventor: Shingo Iwasaki, Fujisawa-shi (JP)

Correspondence Address: MORGAN & FINNEGAN, L.L.P., 3 WORLD FINANCIAL CENTER, NEW YORK, NY, 10281-2101, US

(21) Appl. No.: 11/556,820

(22) Filed: Nov. 6, 2006

(30) Foreign Application Priority Data
Nov. 11, 2005 (JP) 2005-328083

(51) Int. Cl. G06F 17/00

(52) U.S. Cl. 715/517; 715/520

(57) ABSTRACT

A layout apparatus recognizes a blank area in a layout area in which first contents have been laid out and controls a layout in the blank area in which second contents are to be laid out based on the recognized blank area.

### BACKGROUND OF THE INVENTION

1. Field of the Invention

The present invention relates to a method of performing a layout of contents that are composed of images and/or text and an apparatus for the same.

2. Description of the Related Art

When contents such as images and/or text for use in a document are laid out in a certain area, a person can manually decide where to lay out individual contents utilizing a composing application and the like (U.S. Pat. No. 5,224,181).

There has also been a technique for evaluating contents layout that is made relying on human intuition or manual operations (US Publication No. 2003/86619).

However, when layout is made manually due to absence of layout information that defines how to lay out contents in a document, a significant burden of trial and error is placed on the operator. Or, when one creates a template that can output content data in a predetermined layout format and uses the template to lay out images and/or text and output the same, he can output only in several fixed patterns.

In addition, when processing is made without considering a blank area caused from a result of layout, an unused blank area can be formed depending on the size or number of contents.

### SUMMARY OF THE INVENTION

An object of the present invention is to provide a layout method and an apparatus therefore that can make effective use of a blank area.

Another object of the present invention is to provide a method of performing a layout of contents, comprising the steps of: recognizing a blank area within a layout area in which fist contents have been laid out; and controlling a layout in the blank area in which second contents are to be laid out based on the recognized blank area.

Another object of the invention is to provide a method of performing a layout of contents, comprising the steps of: controlling a layout of first contents based on a first template; recognizing a blank area within a layout area in which the first contents have been laid out; creating a second template for controlling a layout in the blank area in which second contents are to be laid out based on the recognized blank area; and controlling a layout of the second contents based on the created second template.

Another object of the invention is to provide a layout apparatus for performing a layout of contents, comprising: recognition unit adapted to recognize a blank area within a layout area in which fist contents have been laid out; and control unit adapted to control a layout in the blank area in which second contents are to be laid out based on the recognized blank area.

Another object of the invention is to provide a layout apparatus for performing a layout of contents, comprising: control unit adapted to control a layout of first contents based on a first template; recognition unit adapted to recognize a blank area within a layout area in which the first contents have been laid out; and creation unit adapted to create a second template for controlling a layout in the blank area in which second contents are to be laid out based on the recognized blank area, wherein said control unit controls the layout of the second contents based on the created second template.

Further features of the present invention will become apparent from the following description of exemplary embodiments (with reference to the attached drawings).

### BRIEF DESCRIPTION OF THE DRAWINGS

FIG. 1A is a block diagram showing the concept of the overall configuration of processing in an embodiment;

FIG. 1B shows an example of rectangle information for use in the embodiment;

FIG. 2 shows an exemplary hardware configuration of the layout apparatus of the embodiment;

FIG. 3 is a flowchart showing an example of layout procedure in the embodiment;

FIG. 4 is a flowchart showing an example of procedure in rectangle layout process S104 of FIG. 3;

FIG. 5 is a view visually showing random positioning of rectangle areas;

FIG. 6 is a flowchart showing a procedure of overlap removal process S1044 of FIG. 4;

FIG. 7 illustrates arrangement of a plurality of rectangle areas and removal of overlaps among them;

FIG. 8 generally illustrates how layout process is performed with combination of a weighting template indicating directionality of arrangement in layout and Simulated Annealing method;

FIG. 9 shows a specific example of a weighting template indicating directionality of arrangement in layout used in the embodiment;

FIG. 10 illustrates an example of rectangle layout process S104;

FIG. 11 is a flowchart showing a procedure of blank area recognition process S107 in FIG. 3;

FIG. 12 is a flowchart showing a procedure of blank area weighting process S108 in FIG. 3;

FIG. 13 shows examples of weighing templates used for a layout in a blank area;

FIG. 14 shows an example of a layout in a blank area in the embodiment; and

FIG. 15 shows an example of a layout result in the embodiment.

### DESCRIPTION OF THE EMBODIMENTS

An embodiment of the present invention will be described in detail with respect to the accompanying drawings. However, the present invention is not limited by the embodiment. Although the description below will show an example where layout of rectangle areas in layout area and in blank area are both performed in the same Simulated Annealing (SA) method, the present invention is not limited to shapes of the layout area and the method how the respective layout is performed. The invention intends to perform layout of rectangle areas in a blank area based on a result where the rectangle or other layout areas are already laid out in the layout area.

<An Exemplary Configuration of the Automatic Layout Apparatus of the Embodiment>

(Conceptual View of the Overall Configuration)

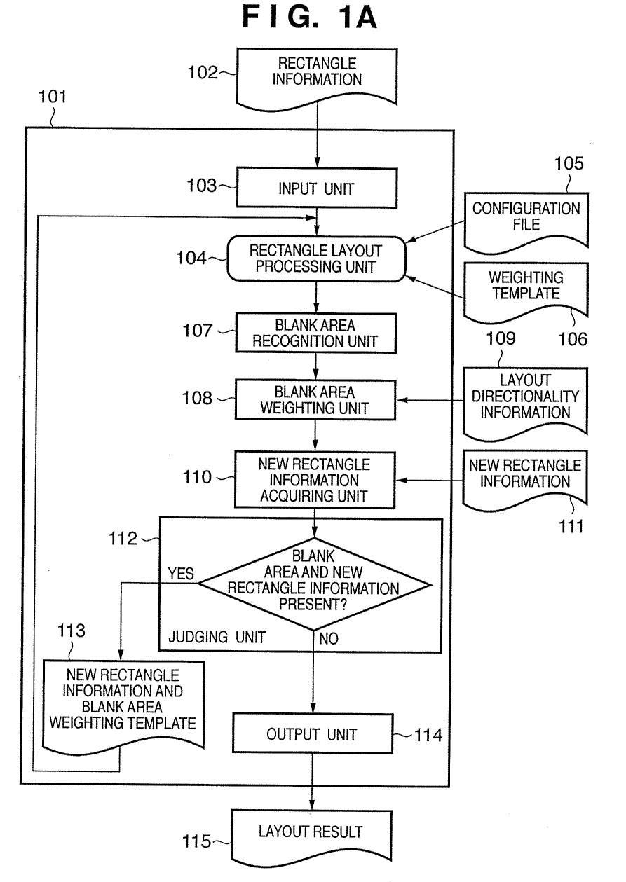

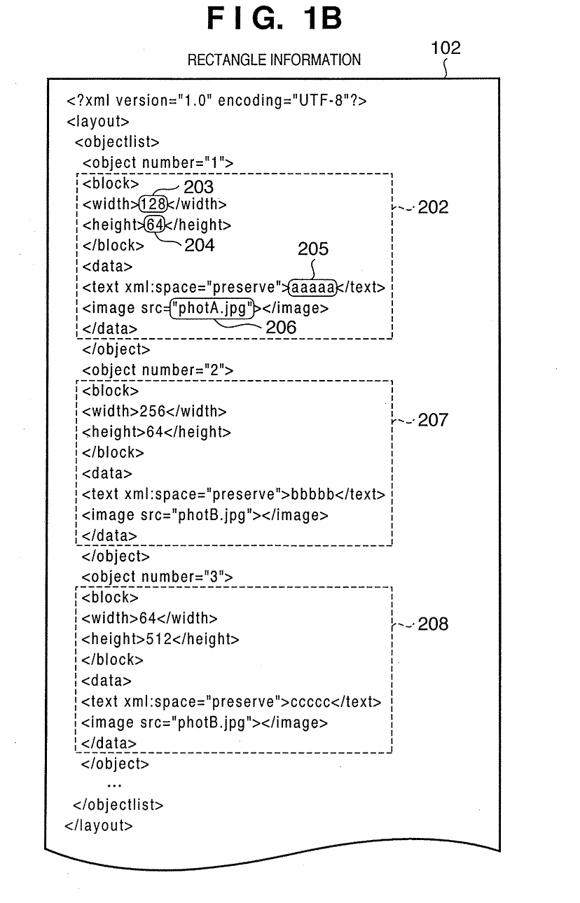

FIG. 1A is a block diagram which conceptually shows the overall configuration of the layout apparatus of the embodiment.

Reference numeral 101 in FIG. 1A denotes the layout apparatus comprising processing units. Reference numeral 102 denotes rectangle information including data that describes rectangle areas to be laid out. An input unit 103 receives the rectangle information. An example of structure of rectangle information 102 will be shown below with reference to FIG. 1B. Reference numeral 104 denotes a rectangle layout processing unit. The rectangle layout processing unit 104 first reads a configuration file 105 that describes various setting information for controlling layout process and a weighting template 106 that indicates directionality of arrangement in layout. The rectangle layout processing unit 104 enlarges/reduces rectangle areas , and arranges the rectangles in an area that is automatically specified by an optimization algorithm, based on the setting information from the configuration file 105, the weighting template 106 and rectangle information 102 received from the input unit 103. That is, the rectangle layout processing unit 104 controls layout of the rectangle areas represented by the rectangle information 102 based on the weighting template 106.

Reference numeral 107 denotes a blank area recognition unit. The blank area recognition unit 107 re-partitions a layout area into squares of grid in view of a layout result which describes positioning coordinates of rectangle areas and/or the sizes of the layout area. The blank area recognition unit 107 matches the partitioned layout area against the positioning coordinates of rectangle areas to find squares which are not filled with a rectangle area and recognizes the not-filled squares as a blank area. Reference numeral 108 denotes a blank area weighting unit, which creates a blank area weighting template over squares of grid which is recognized as a blank area by the blank area recognition unit 107. More specifically, the blank area weighting unit 108 creases a blank area weighting template indicating directionality of arrangement in layout for arranging rectangle areas in a blank area from layout directionality information 109 that describes a certain directionality of layout, e.g., centering arrangement and gathering upward arrangement. Reference numeral 110 denotes a new rectangle information acquiring unit, which obtains new rectangle information 111 to be embedded in a blank area.

A judging unit 112 passes new rectangle information and blank area weighting template 113 to the rectangle layout processing unit 104, when the judging unit 112 has been judged in the previous process that there are a blank area and new rectangle areas from the new rectangle information 111. The blank area weighing template is a template for controlling arrangement of the new rectangle areas in a blank area at which the new rectangle areas are to be laid out. The rectangle layout processing unit 104 enlarges/reduces rectangle areas and automatically arranges the rectangle areas within a specified layout area by an optimization algorithm, according to new rectangle information 111, the blank area weighting template from the layout directionality information 109 and the setting information from the configuration file 105. That is, the rectangle layout processing unit 104 controls positions in the blank area at which new rectangle areas are to be laid out based on the blank area recognized by the blank area recognition unit 107.

On the other hand, if it is judged that there is no blank area or new rectangle area, an output unit 114 compiles a result of layout such as positioning coordinates and vertical and horizontal sizes for each rectangle area and then outputs the layout result 115. Above processing realizes automatic layout of rectangle areas that effectively uses the blank area.

FIG. 1B shows an example of rectangle information 102 that are input to the input unit 103 or new rectangle information 111 of the embodiment. In general, a size of rectangle area indicated in the new rectangle information 111 is smaller than a size of rectangle area indicated in the rectangle information 102, but there is no other difference between the rectangle information 102 and the new rectangle information 111. Here, the rectangle information is illustrated in the form of XML data as a structured document. The rectangle information includes size information indicating the vertical and horizontal sizes of a rectangle area, and text data and/or image data for describing contents to be laid out, or connection information for accessing image data.

Reference numeral 202 denotes a block that describes information on one rectangle area, and reference numerals 203 and 204 denote the horizontal and vertical sizes of the rectangle area, respectively. At 205 and 206, object data (i.e., text data 205 or path (connection information or pointer) 206 for linking to image data) that is associated with the rectangle area is indicated. Although description of rendering the object data in the rectangle areas is omitted in this embodiment, when object data linked based on connection information is to be laid out, the object data can be laid out with being associated with rectangle information. Reference numerals 207 and 208 denote blocks that describe information on the second and third rectangle areas included in rectangle information, respectively. Either the input unit 103 or the new rectangle information acquiring unit 110 reads rectangle information in such XML data format and then identifies information on a rectangle area whose layout should be controlled.

Although the example in FIG. 1B shows an example of a structured document in XML data as representation of rectangle information, the scope of the invention is not limited to XML data, rectangle information may be represented as a structured document in HTML or SGML or as simple text data.

(Exemplary Hardware Configuration of the Layout Apparatus of the Embodiment)

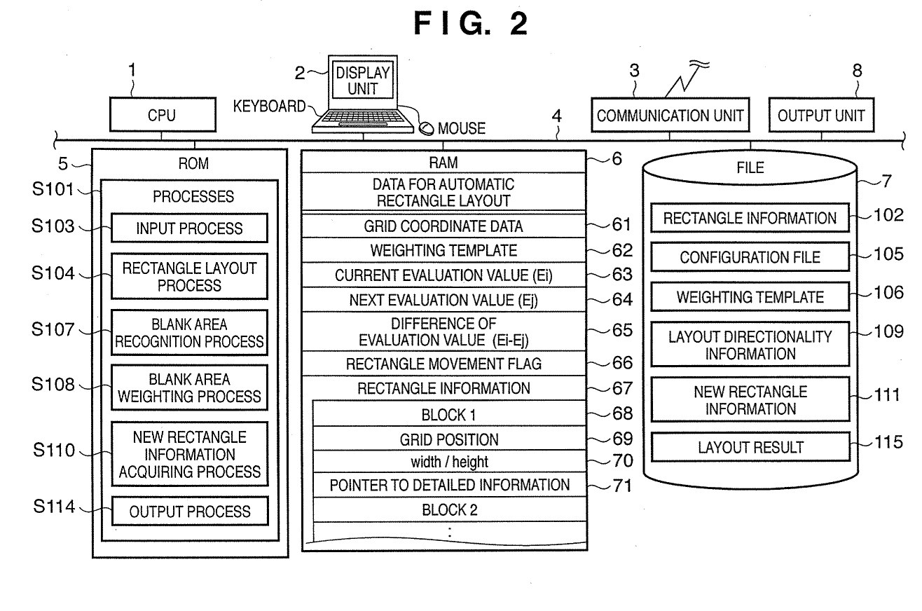

FIG. 2 shows an example of hardware configuration of the layout apparatus that performs processing of the embodiment shown in FIG. 1A. FIG. 2 only illustrates components necessary for describing the embodiment and omits other components.

Reference numeral 1 denotes a CPU for controlling the processing of the entire layout apparatus. Reference numeral 2 denotes a display unit for giving instructions to the layout apparatus from an operator or for indicating condition of the layout apparatus, including an operation unit such as a keyboard and mouse. Reference numeral 3 denotes a communication unit that is utilized for receiving rectangle information 102 to be laid out and/or transmitting a layout result 115. Reference numeral 4 denotes a system bus that connects the CPU 1 to each processing unit, including a data bus, control bus and so forth.

Reference numeral 5 denotes ROM for storing stationary information for the layout apparatus, which may be a rewritable storage device such as flash memory or non-writable storage device. In this example, programs for realizing the processing units shown in FIG. 1A (denoted with adding “S” before the same reference numerals as FIG. 1A.) are stored in the ROM 5. Other functions necessary for basic system operation such as an OS or drivers for peripherals which are not significant for description of the embodiment are not shown. The programs may also be stored in a file 7 of disk, which will be discussed later, and loaded to the RAM 6 for execution by the CPU 1.

Reference numeral 6 denotes RAM that serves as main storage unit for use as temporary storage. Various data can be temporarily stored in the RAM 6 in accordance with program execution at the CPU 1, but description here refers to an example of data storing areas that are used in automatic rectangle layout of the present invention. These data storing areas are used for the same role both in the initial automatic layout of rectangle areas in a layout area and in secondary automatic layout of rectangle areas in a blank area.

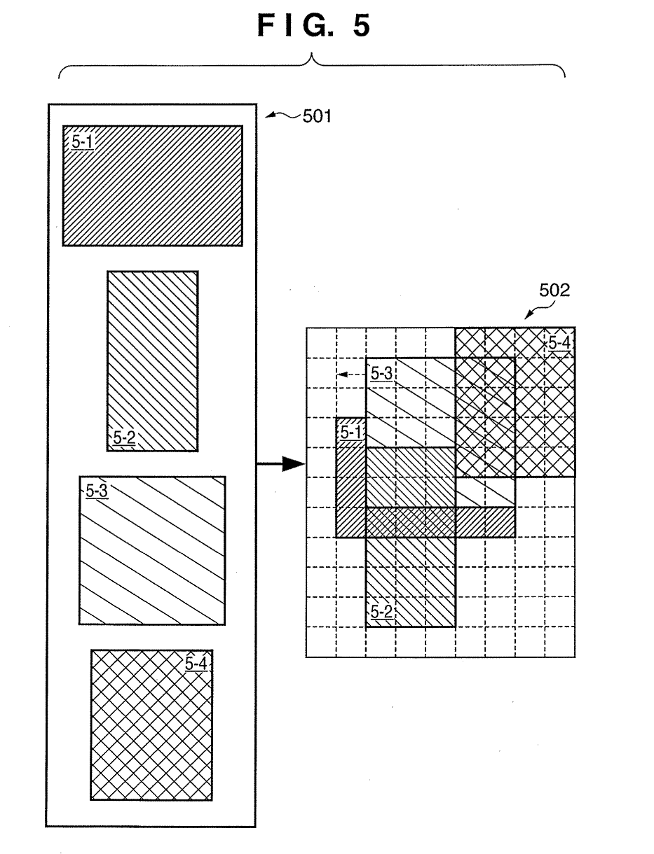

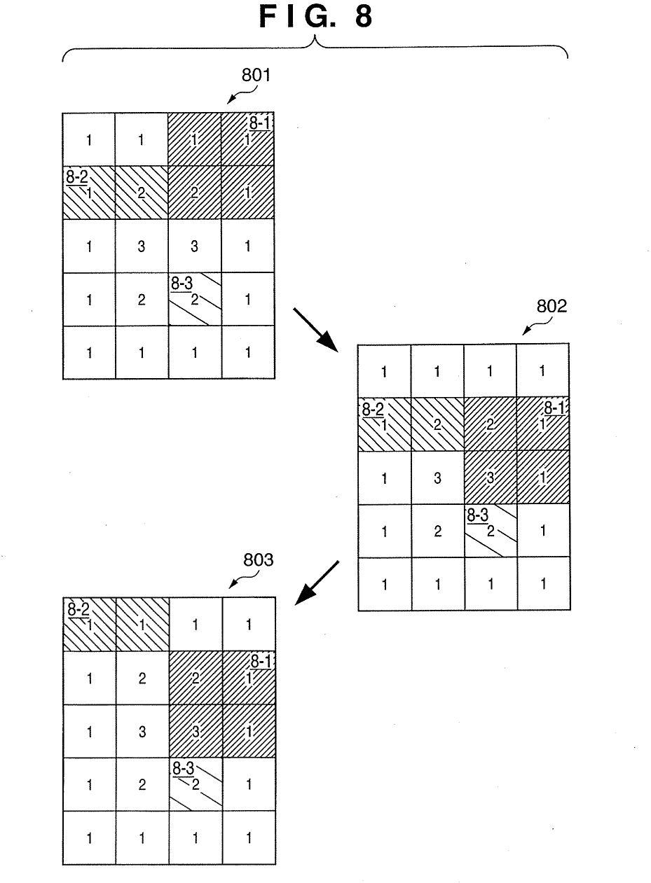

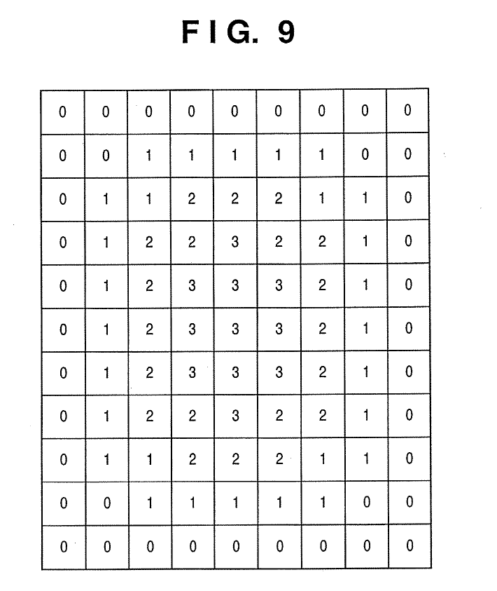

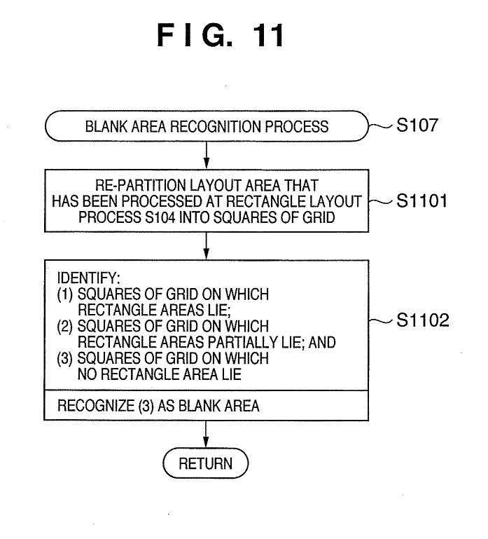

Reference numeral 61 denotes grid coordinate data that indicates a grid (see the right figure in FIG. 5) onto which rectangle areas are laid out. Reference numeral 62 denotes a weighting template that weighs each square of a grid (see FIGS. 9 and 11). Reference numerals 63 to 66 denote intermediate results that are computed in the course of automatic layout according to Simulated Annealing (SA) method of the embodiment (SA method will be described below with reference to FIG. 8). Reference numeral 63 denotes a current evaluation value (Ei) indicating the current energy; 64 denotes a next evaluation value (Ej) indicating the next energy after arbitrary movement of a rectangle area; 65 denotes the difference of evaluate value (Ei-Ej) between the current and next evaluation values, that is used for determination of whether to continue movement of rectangle areas; and 66 denotes a rectangle movement flag that indicates whether movement should be continued or not from an operation result of SA method.

Reference numeral 67 denotes rectangle information that indicates rectangle areas for use in automatic rectangle layout. The rectangle information 67 need not have all information in FIG. 1B. The automatic layout can be performed as long as a grid position 69 (e.g., coordinates of the upper left corner of the rectangle area on grid) and the width and height of the rectangle area 70 are provided for block 1 (68). Reference numeral 71 denotes a pointer to detailed information (image data and/or text data to be rendered in the laid out rectangle area) shown in FIG. 1B that is stored in the file 7. Subsequently, pieces of block information as many as rectangle areas to be laid out are stored.

Reference numeral 7 denotes a file that is stored in a device capable of bulk storage such as a hard disk, having stored therein information necessary for automatic layout process of the embodiment. In the file 7, data files shown in FIG. 1A are illustrated with the same reference numerals. In the case where a program is loaded to the RAM 6 for execution, the programs shown in ROM 5 are also stored in the file 7.

Reference numeral 8 denotes an output unit for outputting layout results and/or information on a rectangle area that has failed to be laid out, including a printer, for example.

<Exemplary Operation of the Layout Apparatus of the Embodiment>

A procedure of initial layout in a layout area and re-layout in a blank area according to the invention by the layout apparatus 101 having the above described configuration will be described in sequence.

<Overall Procedure>

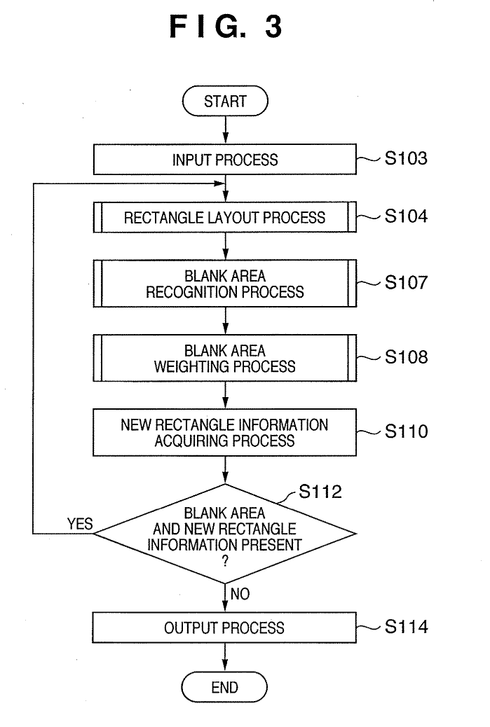

FIG. 3 is a flowchart showing the overall procedure of the embodiment. Reference numerals of steps in FIG. 3 correspond to the processing units of FIG. 1A and the processes in ROM 5 of FIG. 2.

Step S103: Input Process

Rectangle information of the format shown in FIG. 1B is input from the input unit 103. The rectangle information may be input to rectangle information 102 in file 7 as XML data from the Internet via the communication unit 3 or from a storage medium such as a CD.

Step S104: Rectangle Layout Process

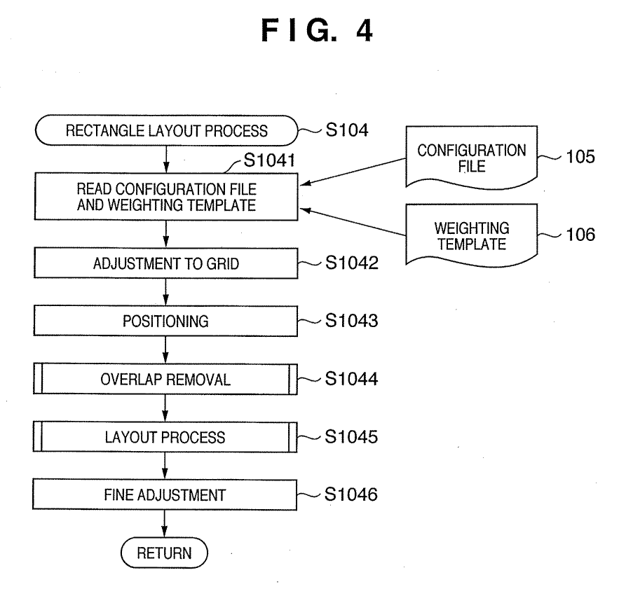

This is a sub-routine for automatically laying out rectangle areas, and as will be described in more detail below with FIG. 4, the rectangle information 102 input at step S103 is laid out in a layout area according to SA method. During this layout process, the configuration file 105 that contains data describing various setting information for controlling layout process and the weighting template 106 that indicates directionality of arrangement in layout are refereed.

Step S107: Blank Area Recognition Process

This is a sub-routine for blank area recognition, which recognizes a blank area from the result of rectangle layout executed at step S104.

Step S108: Blank Area Weighing Process

This is a sub-routine for blank area weighting for creating a blank area weighing template. This blank area weighing process performs weighting for indicating directionality of arrangement for laying out rectangle areas of lower importance e.g., using an advertisement in the case of newspaper or magazine in a portion of the layout result that is recognized as a blank area at step S107. Specifically, this blank area weighting process references the layout directionality information 109 that indicates directionality for laying out rectangle areas within a blank area such as centering arrangement or gathering upward arrangement, and then creates a blank area weighting template that indicates directionality of arrangement in layout to be performed. A blank area weighting template is a template for controlling a position in a blank area at which new rectangle areas described in the new rectangle information 111 should be laid out.

Step S110: New Rectangle Information Acquiring Process

At this step, new rectangle information 111 of lower importance, e.g., for an advertisement, to be newly laid out in a blank area recognized at step S108 is obtained. The new rectangle information 111 may be provided in the file 7 in advance, input locally via some input device, or provided over a communication line. Although the new rectangle information 111 is described as rectangle areas of low importance, it is not limited to the rectangle areas.

Step S112: Judging Whether a Blank Area and New Rectangle Information are Present

If a blank area is recognized at blank area recognition process at step S107 and it is determined at step S110 that new rectangle information 111 has been obtained, the procedure returns to step S104. And rectangle layout process (step S104) is performed again with the new rectangle information 111 and the blank area weighting template created at step S108. In other words, in the initial rectangle layout process, rectangle information 102, configuration file 105 and weighting template 106 are used, but in the second rectangle layout process, new rectangle information and blank area weighting template 113, and configuration file 105 are used. That is, in the second rectangle layout process, positions of new rectangle areas described in the new rectangle information 111 in the blank area are controlled based on the blank area recognized at step S107.

When there is no blank area or no new rectangle information 111 for new rectangle areas to be embedded in a blank area, the procedure proceeds to step S114.

S114: Output Process

When layout finishes, a layout result (the result of layout, such as information on coordinates at which the rectangle areas are positioned and vertical and horizontal sizes of the rectangle areas) is compiled for each rectangle area. The result can be output as a layout result 115 to the file 7 in the layout apparatus, printed out as hard copy via the output unit 8, or output over a communication line by the communication unit 3, as required. The result can also be output onto a network including the Internet by the communication unit 3. The layout result can be output with being formatted in XML data.

<Detailed Process at Each Processing Unit and a Specific Example>

In the following, examples of processes done at each of the processing units in the embodiment will be described in detail with reference to an illustrative example.

An example of rectangle areas that are defined by rectangle information 102 input to the input unit 103 is shown in a document 501 of FIG. 5. A document 501 contains rectangle areas 5-1, 5-2, 5-3 and 5-4 that correspond to images and/or text to be laid out, and the rectangle areas are different in vertical and horizontal sizes.

<Rectangle Layout Processing Unit 104: S104>

Processing by the rectangle layout processing unit 104 will be described with respect to the flowchart of FIG. 4.

The configuration file 105 that describes various setting information for controlling layout process and the weighting template 106 indicating directionality of arrangement in layout are read from the file 7, for example, and initial settings necessary for controlling layout of rectangle areas are performed (S1041). The vertical and horizontal sizes of each rectangle area are adjusted to sizes that can be divided by the width of specified divided areas (i.e., squares of grid) such as by enlarging the rectangle area if necessary (S1042).

The rectangle areas partitioned into squares of grid are randomly positioned so that the rectangle areas do not lie out the layout area (S1043). This process of adjustment to grid is shown in FIG. 5, where the rectangle areas partitioned into squares of grids are randomly arranged in the layout area also partitioned into squares of grid such that any of the four corners of a rectangle area exactly fits in one square of grid as shown at 502 in FIG. 5. At this point, the rectangle areas may be overlapping with each other.

(Overlap Removal Process: S1044)

Overlap removal process is performed to remove overlaps among the rectangle areas by moving or, if necessary, reducing the sizes of the rectangle areas according to a predetermined rule (S1044).

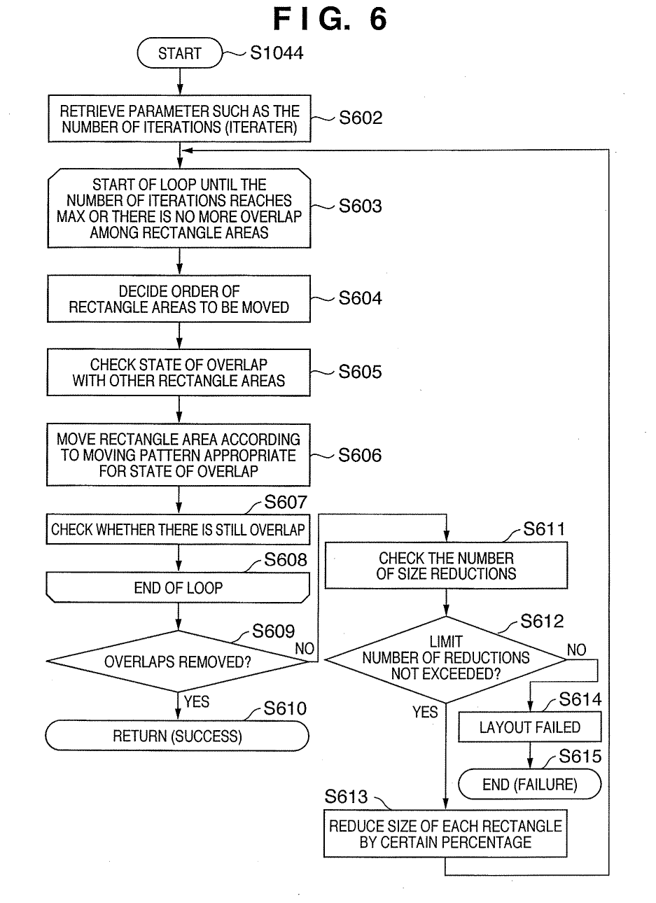

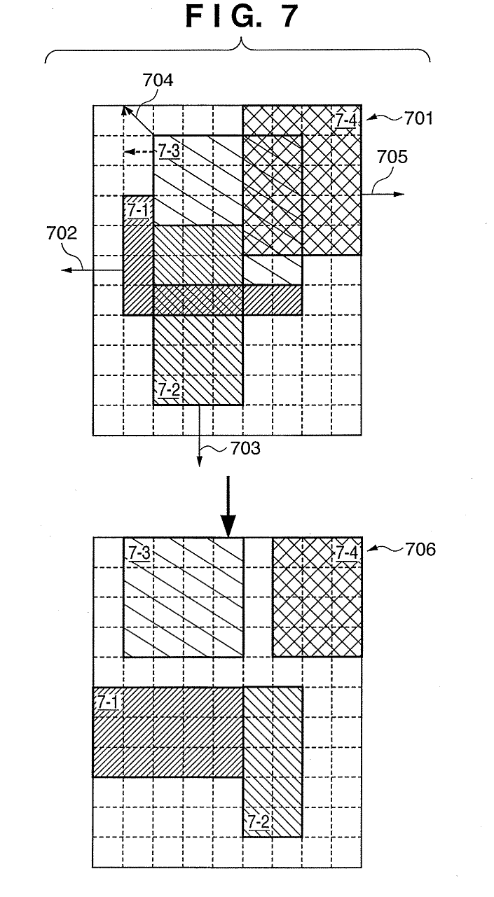

FIG. 6 is a flowchart showing an exemplary procedure of overlap removal process and FIG. 7 is a view visually showing a state in which overlaps are removed in the course of removing overlaps among rectangle areas. Details on overlap removal process will be described below with FIGS. 6 and 7.

First, at step S602, various setting information for controlling layout process, e.g., set values such as the number of iterations (the upper limit (Max) of a parameter (Iterater) for controlling the number of loops) and the number of size reductions, is retrieved from the configuration file 105.

At step S603, loop of overlap removal is started. Processes up to step S608 are repeated until the parameter (Iterater) for controlling the number of loop reaches the upper limit (Max) set as the number of iterations or until there is no overlaps among the rectangle areas.

At step S604, the order of rectangle areas to be moved among the rectangle areas (e.g., rectangle areas 7-1 to 7-4 contained in the document 501 of FIG. 5) is decided. At step S605, in accordance with the order decided at the previous step S604, the state how the target rectangle area to be moved overlaps other rectangle areas is checked. At step S606, the target rectangle area is moved according to a moving pattern appropriate the state how the target rectangle area overlaps other rectangle areas.

At step S607, it is checked whether there are still overlaps among the rectangle areas after the target rectangle area is moved. At step S608, it is determined whether it is possible to remove overlaps among the rectangle areas and whether the number of loops has exceeded the upper limit number of iterations, and overlaps among the rectangle areas are removed within the number of iterations that has been set. For example, after rectangle area 7-1 is first selected as the target of movement and overlaps are removed with respect to rectangle area 7-1, presence of overlaps is checked for remaining rectangle areas 7-2 to 7-4 as well sequentially. If there is an overlap portion, the rectangle area currently selected as the target for movement is moved in the layout area one by one so as to remove overlaps altogether.

It is judged at step S609 whether overlaps among the rectangle areas have been removed or not. If all overlaps have been removed (Yes at S609), the procedure proceeds to step S610, where processing associated with overlap removal process is terminated. However, if it is judged at step S609 that overlaps among the rectangle areas have not been removed (No at S609), the procedure proceeds to step S611.

If overlaps among the rectangle areas have failed to be removed (e.g., if the number of iterations has been exceeded by the number of loops), the number of size reductions is checked at step S611. If the number of size reductions has not been exceeded the limit number of reductions at step S612 (Yes at S612), the procedure proceeds to step S613. And each of the rectangle areas is reduced in size by a certain percentage given by the configuration file 105 and the procedure returns to step S603 to perform removal of overlaps again.

However, if the number of size reductions has been exceeded the limit number of reductions (No at S612), the procedure proceeds to step S614, where it is determined that overlaps among the rectangle areas cannot be removed in the end with the limit number of size reductions and the limit number of loops for overlap removal and then failure in layout is notified (S614), and processing is terminated (S615).

FIG. 7 illustrates arrangement of a plurality of rectangle areas and removal of overlaps among the rectangle areas.

A state is shown at 701 of FIG. 7, in which a plurality of rectangle areas are positioned in a layout area in arrangement process (which corresponds to 502 of FIG. 5). In view of overlap relations among the rectangle areas, rectangle areas 7-1 to 7-4 are both moved in the directions of arrows 702 to 705 respectively and reduced in size (reduced vertically and horizontally by one square of grid). It results in a state in which all overlaps have been finally removed in the arrangement of the rectangle areas as shown at 706 of FIG. 7.

(Layout Process: S1045)

When overlaps have been removed in overlap removal process (S1044 of FIG. 4) described above with FIG. 6, layout process based on an optimization algorithm method is performed (S1045) . A layout process positions the rectangle areas optimally within a layout area in accordance with contents of a weighting template that indicates directionality of arrangement in layout. Hereinafter, a layout process with an optimization algorithm method will be described with reference to FIGS. 8, 9 and 10.

Simulated Annealing method (herein “SA method”) can be utilized as an optimization algorithm method for layout process. Although detailed description on SA method is omitted, SA method is a scheme for solving a combinational optimization problem.

An example of the method is that “the temperature of a solid is increased until the solid has sufficient free energy, and while the solid is subsequently cooled with its temperature being controlled, its free energy is minimized through a certain procedure.” Assume that a solid S has energy Ei when current state Si of the solid S is given. By randomly selecting particles and moving the selected particles by a random amount, the next state Sj of the solid S that has energy Ej is generated. When energy Ei in the current state is equal to or smaller than energy Ej in the next state, that is, when
ΔE=Ei−Ej≧0 (2)
the movement is adopted so that Sj becomes the current state.

On the other hand, if energy Ei in the current state is greater than energy Ej in the next state, that is, when
ΔE=Ei−Ej>0 (2)
whether to move the particles is determined probabilistically based on Formula (3) below.
Prob=e^{-(ΔE/(KB·T))} (3)
where KB represents a Boltzmann constant and T represents temperature.

In this case, the criterion for deciding whether to move particles is known as Metropolis Algorithm that is based on an enormous number of iterations. This entire method of solution is called SA method. In layout process of the embodiment, this SA method is applied to control layout of rectangle areas.

FIG. 8 generally illustrates how a layout process is performed with combination of the weighting template 106 that indicates directionality of arrangement in layout and SA method. Although four rectangle areas are laid out in a 9×9 grid in this example, for the sake of brevity, FIG. 8 illustrates layout of three rectangle areas in a 4×4 grid. It will be known by a example in FIG. 8 that the SA method can be applied to a general layout process.

At 801 of FIG. 8, there is a grid of a layout area on which three rectangle areas 8-1 to 8-3 are arranged. The sum of weighting values that are assigned to squares of the grid on which each rectangle area is positioned, is handled as an evaluation value.
Rectangle area 8-1: 1+1+2+1=5 (4)
Rectangle area 8-2: 1+2=3 (5)
Rectangle area 8-3: 2 (6)
In this case, the evaluation value for the all three rectangle areas is determined as Formula (7):
(5+3+2)×10=100 (7)
In Formula (7), in order to handle an evaluation value 1 as 10 points, the sum of evaluation values (4) to (6) is multiplied by 10.

Determining evaluation values with rectangle area 8-1 being moved in a random direction, e.g., positioned as shown at 802 of FIG. 8, results are as Formulas (8) to (11):
Rectangle area 8-1: 2+1+3+1=7 (8)
Rectangle area 8-2: 1+2=3 (9)
Rectangle area 8-3: 2 (10)
In this case, the evaluation value for all three rectangle areas is determined as Formula (11):
(7+3+2)×10=120 (11)

Since the new evaluation value (120: Formula (11)) after movement of rectangle area 8-1 is greater than the previous evaluation value (100: Formula (7)), the value by Formula (11) is adopted based on the relation of Formula (1). In other words, the position of the rectangle area 8-1 is adopted as the position after movement (i.e., the position shown at 802 of FIG. 8 for which the new evaluation value is determined) and therefore, the rectangle area 8-1 is arranged as shown at 802.

Next, determining evaluation values with the rectangle area 8-2 being moved in a random direction, e.g., positioned as shown at 803 of FIG. 8, results are as Formulas (12) to (14) below:
Rectangle area 8-1: 2+1+3+1=7 (12)
Rectangle area 8-2: 1+1=2 (13)
Rectangle area 8-3: 2 (14)
In this case, the evaluation value for all three rectangle areas is determined as Formula (15).
(7+2+2)×10=110 (15)

Since the new evaluation value after the movement of rectangle area 8-2 (110: Formula (15)) is smaller than the previous evaluation value (120: Formula (11)), the layout processing unit 403 decides to adopt the movement of rectangle area 8-2 probabilistically according to Formula (3) based on the relation of Formula (2).

Assuming that the current temperature is 100° C. and Boltzmann coefficient is 1,
ΔE=Ei−Ej=120−110=10 (16)
Prob=e^{-(ΔE/(KB·T))}=0.9048 (17)

In addition, aside from these calculations, a random value as Boltzmann coefficient is extracted between 0 and 1. If 0.6 is determined, for example, since 0.6<P (=0.9048), the position after movement (i.e., the position at 803 of FIG. 8 for which the new evaluation value is obtained) is adopted as the position of the rectangle area 8-2 and therefore, the rectangle area 8-2 is arranged as shown at 803.

Reversely, if the randomly extracted value is 0.95, 0.95>P(=0.9048). In this case, the layout processing unit with optimization algorithm 403 does not adopt the movement of the rectangle area 8-2 according to a probabilistic determination method based on Formula (3). Therefore, the position of the rectangle area 8-2 remains as shown at 802 of FIG. 8.

As to the current temperature, it is preferable to determine the current temperature by which the result of calculation of Prob is not biased too much, tentatively in advance with balance to the evaluation value (10 points relative to value 1). Although the calculation illustrated above assumes a temperature of 100° C., the scope of the present invention is not limited to the temperature.

In a layout process, an evaluation value for overall layout is determined based on the positions of the rectangle areas and weighting values, and the rectangle areas are laid out at optimal positions in accordance with relations among evaluation values (e.g., Formulas (1) to (3)).

FIG. 9 illustrates an example of a weighting template in the 9×9 grid in this example that directs the four rectangle areas at 706 of FIG. 7 to be gathered toward the center without space among the four rectangle areas.

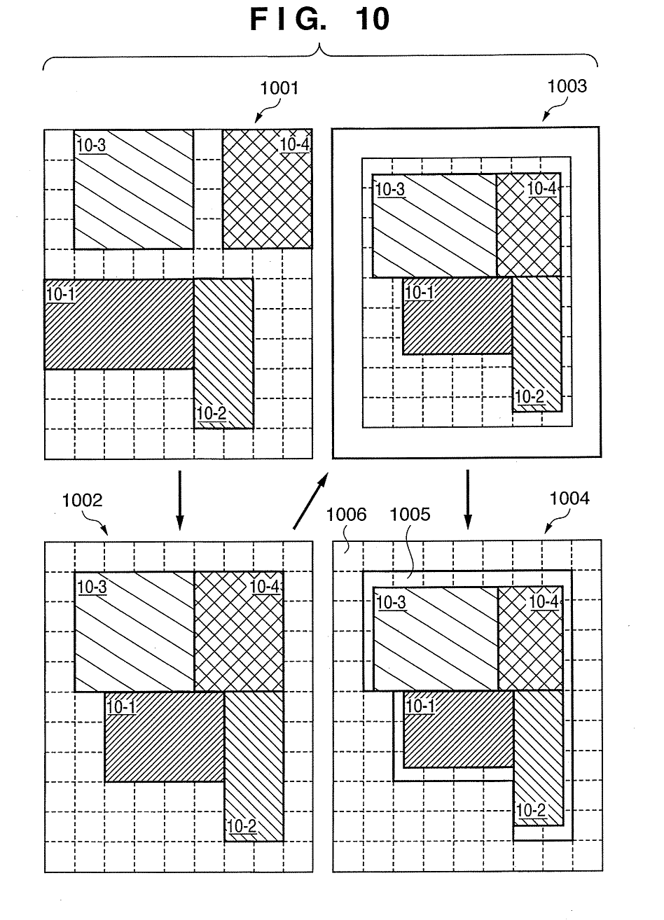

FIG. 10 illustrates a layout process with SA method performed in a case overlaps among the rectangle areas have been removed.

A state is shown in 1001 of FIG. 10, in which overlaps among rectangle areas 10-1 to 10-4 have been removed (corresponding to 706 of FIG. 7). FIG. 10(b) shows A result of layout in SA method by the rectangle layout processing unit 104. The rectangle areas are laid out with being clustered in the center without space among the rectangle areas.

(Fine Adjustment: S1046)

This step removes spaces between the laid out rectangle areas, that are formed by putting the vertical and horizontal sizes of a rectangle area fit in squares of grid back to sizes that correspond with the aspect ratio of the original image. This includes two processes:
(1) Put the size of each rectangle area back to a size that maintains aspect ratio of the original rectangle area prior to being partitioned into squares of grid. back to sizes that maintain the aspect ratio before the rectangle areas are positioned on squares of grid.
(2) As spaces are formed between the put-back rectangle areas, remove the spaces.

Spaces are removed in the following manner:
(2-1) Determine the distance between the center of the layout area and the center of the respective rectangle areas.
(2-2) Move first rectangle area that is closest to the center of layout area toward a rectangle area that is closest to the first rectangle area until the both sides of the first and closest rectangle areas come into contact.
(2-3) Move second rectangle area that is second closest to the center of layout area toward a rectangle area closest to the second rectangle area until the both sides of the second and closest rectangle areas come into contact.
(2-4) If a target rectangle area to be moved cannot be moved because the target rectangle area is in contact with other two rectangle areas at two sides, move a rectangle area whose center is farthest from the center of the layout area so as to obtain a layout result which has no space among all rectangle areas.

A result of applying such fine adjustment to 1002 of FIG. 10 is shown at 1003 of FIG. 10.

<Blank Area Recognition Unit 107: S107>

Next, an example of blank area recognition process that consists of the sub-routine at step S107 of FIG. 3 will be described in detail with reference to the flowchart of FIG. 11 and 1004 of FIG. 10 that illustrates recognition of a blank area.

Step S1101: Re-partition the Layout Area into Squares of Grid

In a layout result that includes positioning coordinates and/or sizes of rectangle areas within a layout area that has been finally determined at rectangle layout process (step S104), the layout area is partitioned into squares of grid again. Here, the grid used at step S104 may be used as it is or the other grids can be also used.

Step S1102: Blank Area Recognition

This step distinguishes at 1004 of FIG. 10:
(1) squares of the grid which are completely filled by the laid out rectangle areas 10-1, 10-2, 10-3 and 10-4;
(2) squares of the grid on which the laid out rectangle areas 10-1, 10-2, 10-3 and 10-4 partially lie (the portion indicated as 1005 of FIG. 10); and
(3) squares of the grid on which the laid out rectangle areas 10-1, 10-2, 10-3 and 10-4 do not lie at all (the portion indicated as 1006 of FIG. 10). The portion 1006 on which the laid out rectangles 10-1, 10-2, 10-3 and 10-4 do not lie at all (the portion (3) of squares) is recognized as a blank area. The procedure then returns.

In this manner of the blank area recognition S1102, it is determined whether or not each square of the partitioned layout area is included in a blank area.

<Blank Area Weighting Unit 108: S108>

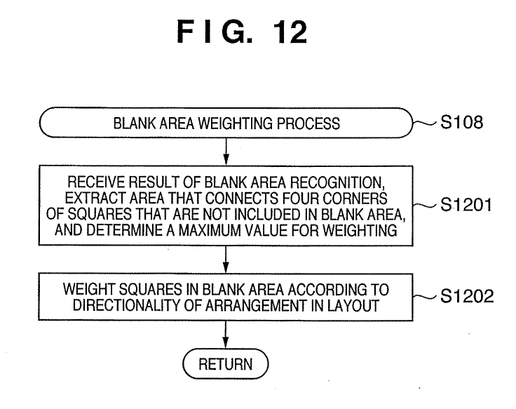

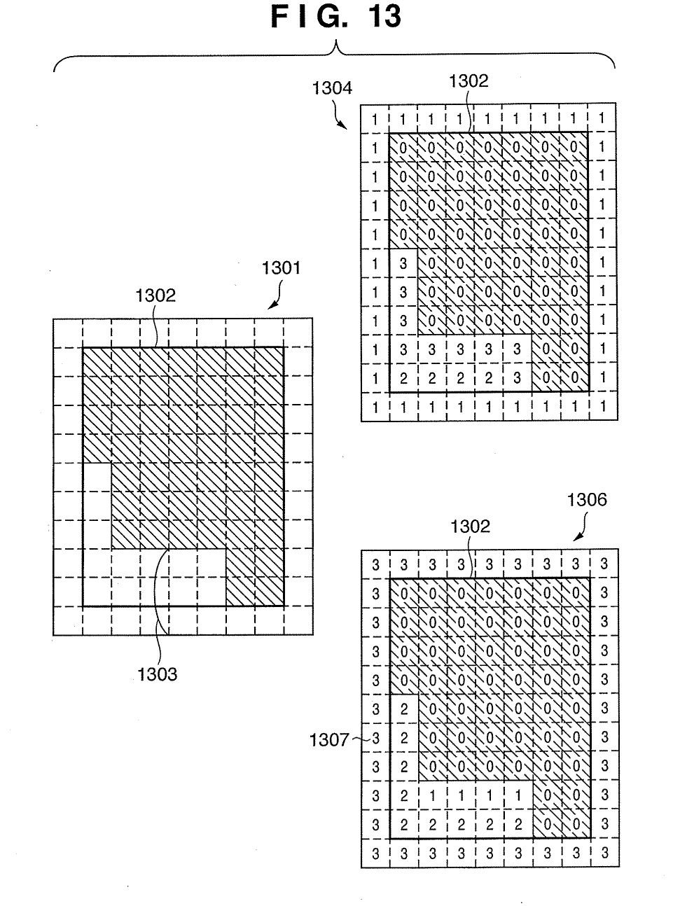

Referring to the flowchart of FIG. 12 and FIG. 13, blank area weighting process that consists of the sub-routine at step S108 of FIG. 3 will be described in detail.

At step S108, the blank area 1006 in the layout area (see 1004 of FIG. 10) is weighted as shown in FIG. 13 and then a blank area weighting template is created. Here, the blank area 1006 in the layout area that has been recognized at blank area recognition at step S107 is weighted in accordance with blank area layout directionality information 109. In other words, the blank area weighting template is a template for controlling a layout in an area recognized as a blank. area in which new rectangle information is to be laid out.

S1201: Re-partition the Layout Result into Two Areas, one Area Including the Laid Out Rectangle Areas and Another Area Not Including the Laid Out Rectangle Areas, and Determine a Maximum Value for Weighting

As shown in 1301 of FIG. 13, the layout result in which rectangle areas are laid out is partitioned into two areas. This re-partitioning into the two areas is performed by connecting the four corners that surround the squares on which the laid out rectangle areas lie perfectly or partially with a straight line (thick line 1302 in the layout view of 1301 of FIG. 13). In the layout view of 1301 of FIG. 13, the layout area is also shown with separated into a blank area (the white portion of the squares) and a laid out portion in which rectangle areas are already laid out (the shaded portion of the squares).

Next, a maximum value for weighting blank area is determined. A point in which the largest number of blank squares are contained between the outer square of the layout area and the laid out portion is found and then the largest number is determined to be the maximum value. In this embodiment, as shown at 1303 in FIG. 13, at a point in which the largest number of blank squares are contained between the outer square of the layout area and the laid out portion, three blank squares exist. Thus, the maximum value for weighting the blank area is set to 3.

The maximum value is not limited to 3. It may be determined from speed or reliability of convergence in SA method for automatic layout. For example, the maximum value may be set to 6 and alternate values such as 4 and 2 may be assigned, or values may not be evenly spaced.

Step S1202: Weight Squares in the Blank Area

At this step, squares of the grid are weighted according to the maximum weighting value “3” determined at step S1201 and the directionality of arrangement in layout.

(A) When Layout Directionality is Centering Arrangement

In this case, a blank area weighting template 1304 for centering arrangement shown in FIG. 13 is created.

(1) Zero is assigned to the laid out portion, which is shaded in the figure. In rectangle layout process, a portion having a square value of 0 is a portion in which no rectangle area is laid out.

(2) A value of 3, which is the maximum weighting value, is assigned to squares in blank area that are neighboring the laid out portion and within a box defined by thick line 1302 connecting the corners in 1304 of FIG. 13.

(3) A value of 2 is assigned to squares that are neighboring the squares to which the maximum weighting value “3” is assigned and within the box defined by thick line 1302 connecting the corners in 1304 of FIG. 13.

(4) A value of “1” is assigned to remaining squares of blank area out of the box defined by thick line 1302 connecting the corners in 1304 of FIG. 13.

In this manner, it is possible to create a blank area weighting template that guides layout in blank areas toward squares having a greater assigned value.

(B) When Layout Directionality is Outward Arrangement

In this case, weighting values are assigned as illustrated by a blank area weighting template for outer arrangement shown in 1306 of FIG. 13.

(1) A value of 0 is assigned to the laid out portion.

(2) A value of 3, which is the maximum weighting value, is assigned to squares of grid that lie outside the box defined by thick line 1302 connecting the corners in 1307 of FIG. 13.

(3) Scores of 2 then 1 are assigned to squares of blank area within the box defined by thick line 1302 connecting the corners, in order of direction toward the center of the layout area in 1306 of FIG. 13.

In the manner described above, it is possible to create a blank area weighting template that guides layout in a blank area toward squares that have a greater assigned value.

The method of assigning weighting values is not limited to the ones illustrated above. In addition, directionality is not limited to centering arrangement and outward arrangement, but a desired layout, e.g., downward arrangement for an advertisement, may be provided.

<Automatic Rectangle Layout Processing Unit 104: S104>

When a blank area weighting template (1304 or 1306 in FIG. 13) is obtained at step S108 and new rectangle information is obtained at step S110, the procedure returns from S112 to S104.

And new rectangle areas provided are laid out in a blank area by SA method used at the initial layout by the rectangle layout processing unit 104 based on the blank area weighting template. In this manner, a layout in a blank area in which new rectangle areas are to be laid out is controlled on the basis of the shape of a blank area or the distance from a reference position (e.g., the outer frame of a content area) to a blank area.

<Illustrative Example of Layout in a Blank Area>

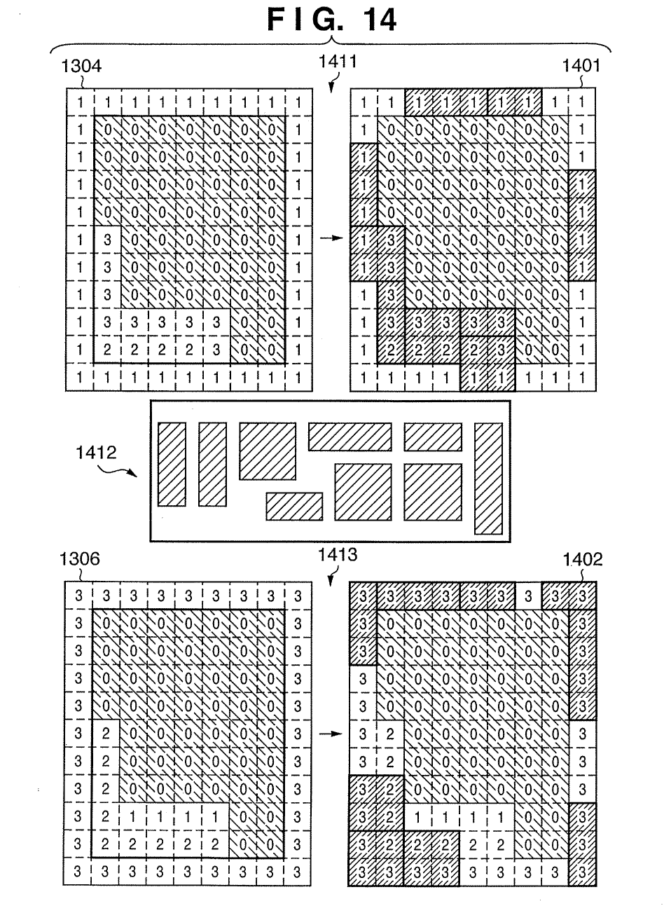

An example of allocating new rectangle areas from new rectangle information 111 in a blank area will be described with reference to FIG. 14 which shows allocation to a blank area.

FIG. 14 shows an exemplary process that is performed when a blank area has been recognized in a result of the initial layout and a blank area weighting template indicating directionality for laying out rectangle areas in the blank area has been created as mentioned above with FIGS. 10 and 12. Since the blank area weighting template that indicates directionality of arrangement of rectangle areas in a blank area can be centering arrangement (1304 in FIGS. 13 and 14) or outward arrangement (1306 in FIGS. 13 and 14) as mentioned above with FIG. 12, description will be given for both the cases.

The description here will refer to a case where nine new rectangle areas that are relatively small (e.g., an advertisement of low importance in a newspaper/magazine) shown in 1412 of FIG. 14 are newly laid out in a blank area.

(1) A case of centering arrangement in layout

Layout in centering arrangement is made as shown in 1411 of FIG. 14. That is, the nine new rectangle areas are automatically laid out using the blank area weighting template 1304 for centering arrangement of FIG. 14 (corresponding to FIG. 13) in SA method described above with FIG. 8.

In this layout of blank area, the nine new rectangle areas are also randomly arranged on the layout area. The overlap removal process at S1044 of FIG. 4 is first performed and subsequently layout process using SA method is performed at S1045. In this case, the layout process at S1045 uses the blank area weighting template 1304 for centering alignment. In this case, the new rectangle areas are not laid out in squares of grid that have a weighting value of 0.

The nine new rectangle areas are finally laid out in centering arrangement in a blank area as shown at 1401 of FIG. 14. When all the new rectangle areas of new rectangle information 111 are laid out, the procedure proceeds from step S112 to step S114.

(2) A case of outward arrangement in layout Layout in outer arrangement is made as shown in 1413 of FIG. 14. Specifically, the nine new rectangle areas are automatically laid out in SA method, which has been described with FIG. 8, using the blank area weighting template 1306 for outward arrangement of FIG. 14 (corresponding to FIG. 13).

In this layout in a blank area, the nine new rectangle areas are also randomly arranged on a layout area. The overlap removal at S1044 of FIG. 4 is first performed and the layout process using SA method is then performed at S1045. In this case, the layout process at S1045 uses the blank area weighting template 1306 for outward arrangement. In this case, the new rectangle areas are not laid out in squares that have a weighting value of 0.

The nine new rectangle areas are finally laid out in the blank area in outward arrangement as shown at 1402 in FIG. 14. When all the new rectangle areas of new rectangle information 111 have been laid out, the procedure proceeds from step S112 to S114.

<Illustrative Example of a Final Layout Result>

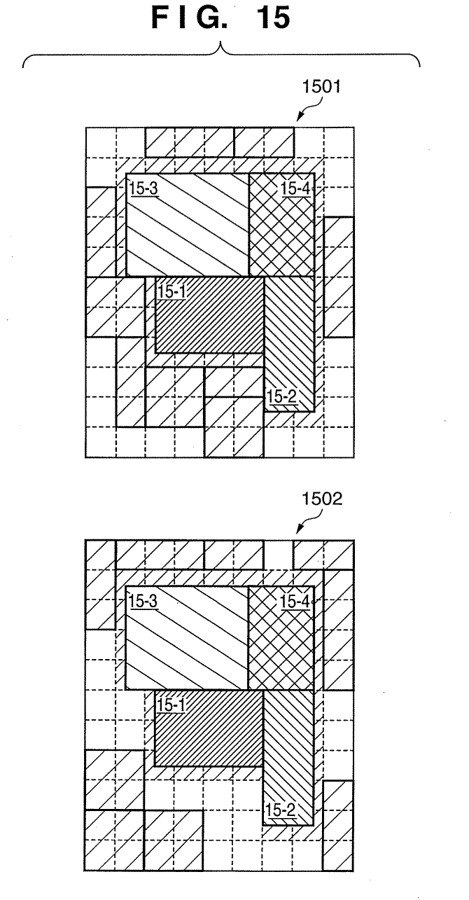

FIG. 15 shows a final layout result provided when layout of rectangle areas as main body in a layout area and layout of new rectangle areas in a blank area are completed in the specific example of the embodiment.

At 1501 of FIG. 15, a result of laying out rectangle areas as main body in centering arrangement and new rectangle areas in a blank area also in centering arrangement, is shown. Meanwhile, at 1502 of FIG. 15, a result of laying out rectangle areas as main body in centering arrangement and new rectangle areas in a blank area in outward arrangement, is shown.

As has been thus described in detail, according to the embodiment, after rectangle areas are laid out in a specified layout area based on certain rectangle information, blank area(s) within the layout area can be detected, and if there is any additional rectangle areas, the additional rectangle areas can be laid out in the blank area(s).

The present invention may be applied to a system that is composed of a plurality of devices (e.g., computers, interfacing devices, readers and printers) or a layout apparatus that is formed of a single device.

The object of the present invention can be also attained by inserting a storage medium that has stored therein a program code for realizing the procedures of the flowcharts shown in the above described embodiment into a system or an apparatus, and a computer (or a CPU or MPU) in the system or the apparatus reading out the program code stored in the storage medium and executing it.

In this case, the program code itself read out from the storage medium realizes the functions of the above described embodiment and the storage medium storing the program code constitutes the present invention.

The storage medium for supplying the program code may be a hard disk, optical disk, magneto-optical disk, CD-ROM, CD-R, magnetic tape, non-volatile memory card or ROM.

It is also contemplated that an operating system (OS) running on the computer performs some or all of actual processing based on instructions in the program code read by the computer so as to realize the functions of the above described embodiment.

The program code read from the storage medium is further written in a function extension board inserted into the computer and/or memory provided in a function extension unit connected to the computer. The functions of the above described embodiment may also be realized by a CPU provided in the function extension board or function extension unit subsequently performing some or all of actual processing based on instructions in the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-328083, filed on Nov. 11, 2005, which is hereby incorporated by reference herein in its entirety.

What is claimed is:

1. A method of performing a layout of contents, comprising the steps of:
recognizing a blank area within a layout area in which fist contents have been laid out; and
controlling a layout in the blank area in which second contents are to be laid out based on the recognized blank area.

2. The method according to claim 1, wherein said controlling step controls the layout in the blank area in which the second contents are to be laid out based on a shape of the blank area.

3. The method according to claim 1, wherein said controlling step controls the layout in the blank area in which the second contents are to be laid out based on a distance from a reference position to the blank area.

4. The method according to claim 1, wherein said controlling step controls the layout in the blank area in which the second content is to be laid out based on a distance from an outer frame of a content area and the blank area.

5. A method of performing a layout of contents, comprising the steps of:
controlling a layout of first contents based on a first template;
recognizing a blank area within a layout area in which the first contents have been laid out;
creating a second template for controlling a layout in the blank area in which second contents are to be laid out based on the recognized blank area; and
controlling a layout of the second contents based on the created second template.

6. The method according to claim 5, wherein said recognizing step determines whether or not each portion of the layout area partitioned into a plurality of portions is within the blank area, and said creating step creates the second template for controlling an area recognized as the blank area in which the second contents are to be laid out based on the recognition result of said recognizing step.

7. A computer-executable program for a computer for performing a layout of contents, comprising the steps of:
recognizing a blank area within a layout area in which fist contents have been laid out; and
controlling a layout in the blank area in which second contents are to be laid out based on the recognized blank area.

8. The computer-executable program according to claim 7, wherein said controlling step controls the layout in the blank area in which the second contents are to be laid out based on a shape of the blank area.

9. The computer-executable program according to claim 7, wherein said controlling step controls the layout in the blank area in which the second contents are to be laid out based on a distance from a reference position to the blank area.

10. The computer-executable program according to claim 7, wherein said controlling step controls the layout in the blank area in which the second contents are to be laid out based on a distance from an outer frame of a content area to the blank area.

11. A computer-executable program for a computer for performing a layout of contents, comprising the steps of:
controlling a layout of first contents based on a first template;
recognizing a blank area within a layout area in which the first contents have been laid out; creating a second template for controlling a layout in the blank area in which second contents are to be laid out based on the recognized blank area; and
controlling a layout of the second contents based on the created second template.

12. The computer-executable program according to claim 11, wherein said recognizing step determines whether or not each portion of the layout area partitioned into a plurality of portions is within the blank area, and said creation step creates the second template for controlling an area recognized as the blank area in which the second contents are to be laid out based on the recognition result of said recognizing step.

13. A layout apparatus for performing a layout of contents, comprising:
recognition unit adapted to recognize a blank area within a layout area in which fist contents have been laid out; and
control unit adapted to control a layout in the blank area in which second contents are to be laid out based on the recognized blank area.

14. The apparatus according to claim 13, wherein said control unit controls the layout in the blank area in which the second contents are to be laid out based on a shape of the blank area.

15. The apparatus according to claim 13, wherein said control unit controls the layout in the blank area in which the second contents are to be laid out based on a distance from a reference position to the blank area.

16. The apparatus according to claim 13, wherein said control unit controls the layout in the blank area in which the second contents are to be laid out based on a distance from an outer frame of a content area to the blank area.

17. A layout apparatus for performing a layout of contents, comprising:
control unit adapted to control a layout of first contents based on a first template;
recognition unit adapted to recognize a blank area within a layout area in which the first contents have been laid out; and
creation unit adapted to create a second template for controlling a layout in the blank area in which second contents are to be laid out based on the recognized blank area,
wherein said control unit controls the layout of the second contents based on the created second template.

18. The apparatus according to claim 17, wherein said recognition unit determines whether or not each portion of the layout area partitioned into a plurality of portions is within the blank area, and said creation unit creates the second template for controlling an area recognized as the blank area in which the second contents are to be laid out based on the recognition result of said recognition unit.
